(19) United States
(12) Patent Application Publication
(10) Pub. No.: US 2003/0096625 A1
(43) Pub. Date: May 22, 2003

(54) Push advertisement in mobile communications network and mobile terminal suitable for the same

(75) Inventors: Mi-Su Lee, Seoul (KR); Jin-Woo Lee, Seoul (KR)

Correspondence Address: LAHIVE & COCKFIELD, 28 STATE STREET, BOSTON, MA, 02109, US

(73) Assignee: AirCross Co., Ltd., Seoul (KR)

(21) Appl. No.: 10/216,329

(22) Filed: Aug. 8, 2002

(30) Foreign Application Priority Data
Sep. 12, 2001 (KR) 2001-56220
Feb. 16, 2002 (KR) 2002-8348

(51) Int. Cl. H04H 1/00; H04Q 7/20; H04M 1/00; H04B 1/38

(52) U.S. Cl. 455/466; 455/566; 455/3.01

(57) ABSTRACT

An advertisement method in a mobile communications network for enhancing the efficiency of the advertisement activity and substantially compensating for the exposure of the advertisement, and a mobile terminal suitable for the advertisement method. An advertisement system pushes advertisement image data, without any user involvement, to the mobile terminal of the user who subscribed to receiving the advertisement, so that the advertisement image data is stored in the mobile terminal and an advertisement image corresponding to the data is displayed when a predetermined event happens in the terminal. Examples of the events include entry to a standby state, wireless internet access trial, transmission of a short message, receiving a call, completion of the wireless internet connection, and turning on/off of the terminal. When receiving a short message of a certain format, the mobile terminal is automatically connected to the advertisement system to receive and store the advertisement image data.

### RELATED APPLICATIONS

This application is related to co-pending Korean Patent Application Serial No. 2001-56220, filed on Sep. 12, 2001, and co-pending Korean Patent Application Serial No. 2002-8348, filed on Feb. 16, 2002, the entire contents of which are hereby incorporated by reference.

### BACKGROUND OF THE INVENTION

1. Field of the Invention

The present invention relates to a method for advertising through a communications network and an apparatus for receiving such advertisement data. More particularly, the present invention relates to an advertisement method in a wireless communications network and a mobile terminal for implementing the method.

2. Description of Related Arts

Product suppliers carry out advertisements, i.e., non-personal information providing activities, for the promotion of the sales of the goods and the enhancement of public relations. While traditional advertisement media include television and radio broadcasting, newspapers, and magazines, banner advertisements or insertion advertisements in Internet contents are prevailing nowadays. In particular, short message advertisements utilizing the short message service (hereinbelow, referred to as “SMS”) are emerging as a new advertisement medium recently.

However, the short message advertisement may have some limitations in the advertisement effect. First, a short message transmitted through the SMS is so short that the advertisement sponsor cannot express the message in detail. More basically, since the mobile terminal is an apparatus mainly targeted for personal communication, most users are not interested in junk messages such as the advertisement short messages and likely to delete the messages just after the receipt of the messages. Considering that most advertisement short messages are directed for sales promotion of goods, such phenomenon may disappoint the sponsors.

Several ideas have been proposed for increasing the effect of the short message advertisement. One example is the targeted transmission disclosed in the Korean Layed-open Patent 2000-72755 published on Dec. 5, 2000 and entitled METHOD AND SYSTEM FOR ADVERTISEMENTS IN A NETWORK. According to the method disclosed in the document, a sponsor or an advertisement service provider selects an advertisement targets based on a certain criterion to send the advertisement short message only to the selected targets. However, regardless of the target transmission, the users of the terminals are not interested in the advertisement short messages unless a provoking cause is provided, and the transmission of the advertisement short messages without the agreement of the receivers may result in the displeasure of the receivers like spam e-mails.

In the Korean Layed-open Patent 2000-300677 published on Jun. 5, 2000 and entitled TARGETED ADVERTISEMENT AND ACTIVE ADVERTISEMENT ACCESS BASED ON INTERNET AND MOBILE TERMINAL and the Korean Layed-open Patent 2001-0002782 published on Jan. 15, 2001 and entitled ADVERTISEMENT SYSTEM USING WIRELESS COMMUNICATIONS TERMINAL disclose methods and systems for providing advertisement information only to subscribers who agreed to receive the advertisement information. According to the documents, the advertisement service provider compensates for the receipt of the advertisement information to each recipient. Since the unit revenue of one advertisement short message is not so high, however, the compensation provided by the advertisement service provider cannot be enough to satisfy the recipient accordingly. Meanwhile, since the recipient of the advertisement information may delete the advertisement short message as soon as the arrival of the message arrive despite of the compensation, the compensation cannot increase the advertisement effect considerably.

On the other hand, since the advertisement short message provided through the SMS push technology is a short and simple text, the message cannot sufficiently appeal to the users of the terminals. Thus, it is preferable to provide an image advertisement such as a still image or a moving picture to enhance the advertisement effect. However, provided for increasing an effect of the advertisement. It is quite difficult to provide the terminal with the image advertisement unless the terminal is connected through the Wireless Internet. A method which substantially increases the advertisement effect is needed to satisfy the sponsors and advertisement service providers.

### SUMMARY OF THE INVENTION

To solve the above problems, one object of the present invention is to provide an advertisement method in a wireless communications network for enhancing the effect of the advertisement activities and substantially compensating for the receipt of the advertisement data of the recipient.

Another object of the present invention is to provide a mobile terminal suitable for implementing the advertisement method.

The advertisement method for achieving one of the above objects is supervised by an advertisement system which may be accessed by the mobile terminal through the wireless communications network. The advertisement system pushes the advertisement image data without any user involvement to the mobile terminal of the user who subscribed to receiving the advertisement, so that the advertisement image data is stored in the mobile terminal and an advertisement image corresponding to the advertisement image data is displayed when a predetermined event occurs in the terminal. The event may be entry to a standby state, wireless Internet access trial, transmission of a short message, receiving a call, completion of the wireless Internet connection, turning on of the terminal, turning off of the terminal, or a combination of at least two of them.

The wireless communications terminal includes a displaying unit; a call processing circuit for transmitting and receiving signals; a nonvolatile memory for storing data; means for storing advertisement image data received from a predetermined server through the call processing circuit in the nonvolatile memory; and means for displaying an advertisement image corresponding to the advertisement image data on the displaying unit when a predetermined event occurs. First, the advertisement system transmits a short message including a predetermined service identification code and a resource locator, so that the terminal can request to the advertisement image data through the network. Upon receiving the request, the advertisement system provides the advertisement image data to the terminal along with a predetermined script program so that the script program stores the advertisement image data in a predetermined location of the nonvolatile memory. Thus, the displaying means can display the advertisement image corresponding to the advertisement image data on the displaying unit when the predetermined event occurs

According to an aspect of the present invention for achieving another one of the above objects, there is provided a wireless communications terminal which automatically receives advertisement image data from an external advertisement server, stores the advertisement image data in its memory, and displays the advertisement image corresponding to the advertisement image data at a predetermined timing. The wireless communications terminal includes a displaying unit; a call processing circuit for transmitting and receiving signals; a nonvolatile memory for storing data; means for storing advertisement image data received from a predetermined server through the call processing circuit in the nonvolatile memory; and means for displaying an advertisement image corresponding to the advertisement image data on the displaying unit when a predetermined event occurs.

According to another aspect of the present invention for achieving another one of the above objects, there is provided a method of displaying an advertisement image by automatically receiving advertisement image data from an external advertisement server, storing the advertisement image data, and displaying the advertisement image corresponding to the advertisement image data at a predetermined timing. The method can be implemented in a wireless communications terminal having a displaying unit, and a nonvolatile memory for storing data. First, the advertisement image data is received from a predetermined server and stored in the nonvolatile memory. Afterwards, the advertisement image data is read out from the nonvolatile memory and the advertisement image corresponding to the advertisement image data is displayed on the displaying unit when a predetermined event occurs in the terminal. The event may be an entry to a standby state, wireless Internet access trial, transmission of a short message, receiving a call, completion of the wireless Internet connection, turning on of the terminal, or turning off of the terminal.

Preferably, a short message including a service identification code and a resource locator is received first when the advertisement image data is received from the server. In case that the service identification code corresponds to a transmission service, the server is accessed the advertisement image data is received from the server. In an alternative embodiment, the advertisement image data is received from the server by WAP push technology.

According to the present invention, the advertisement sponsor can provide personalized advertisement based on the characteristic features of users of mobile terminals. Considering that the mobile terminal is carried by the user for 24 hours, the sponsor can maximize the effect of the advertisement by the usual and repetitive exposure of the advertisement. The operator of the advertisement system can obtain more advertisement revenues from the sponsor and provide substantial incentives to the recipient of the advertisement.

Meanwhile, since the advertisement data is downloaded while the terminal is not busy, the service result in little inconvenience of the user. In particular, the inconvenience is reduced because the user can cancel the subscription after the purchase of the terminal or subscribe at any time.

### BRIEF DESCRIPTION OF THE DRAWINGS

The above objectives and advantages of the present invention will become more apparent by describing in detail preferred embodiments thereof with reference to the attached drawings in which:

FIG. 1 illustrates an example of the connective relationship between an advertisement system for implementing an advertisement method of the present invention and a mobile terminal;

FIG. 2 is a flowchart showing a general process of implementing the advertisement method of the present invention;

FIG. 3 illustrates an embodiment of the advertisement system shown in FIG. 1 and its network environment;

FIG. 4 is a flowchart showing the advertisement method carried out in the advertisement system and in the network environment shown in FIG. 3;

FIG. 5 is a block diagram of an embodiment of the mobile terminal shown in FIG. 3;

FIG. 6 is a block diagram showing the configuration of an embodiment of the control program shown in FIG. 5;

FIG. 7 is a flowchart showing steps of receiving and handling a short message in the mobile terminal terminal;

FIG. 8 shows an exemplary frame structure of data provided by the advertisement system to the mobile terminal;

FIGS. 9A through 9C show an example of the allocating of advertisement data storing space in the memory of the mobile terminal;

FIG. 10 is an example of an advertisement exposure management table;

FIG. 11 is a flowchart showing the process of determining the advertisement image to be exposed and displaying the image in the mobile terminal;

FIGS. 12A and 12B are tables for explaining the data management and targeted transmission for each individual in the advertisement system;

FIG. 13 illustrates another embodiment of the advertisement system shown in FIG. 1 and its network environment;

FIG. 14 is a flowchart showing the advertisement method carried out in the advertisement system and in the network environment shown in FIG. 13;

FIG. 15 is a block diagram showing the configuration of the program executed by the mobile terminal suitable for the advertisement method of FIG. 14;

FIG. 16 illustrates another example of the connective relationship between the advertisement system and the mobile terminal;

FIG. 17 generally shows the configuration of the program executed by the mobile terminal of FIG. 16; and

FIG. 18 is a flowchart showing another embodiment of the advertisement method of the present invention carried out in the network of FIG. 16 and utilizing a push proxy gateway.

### DETAILED DESCRIPTION OF PREFERRED EMBODIMENTS

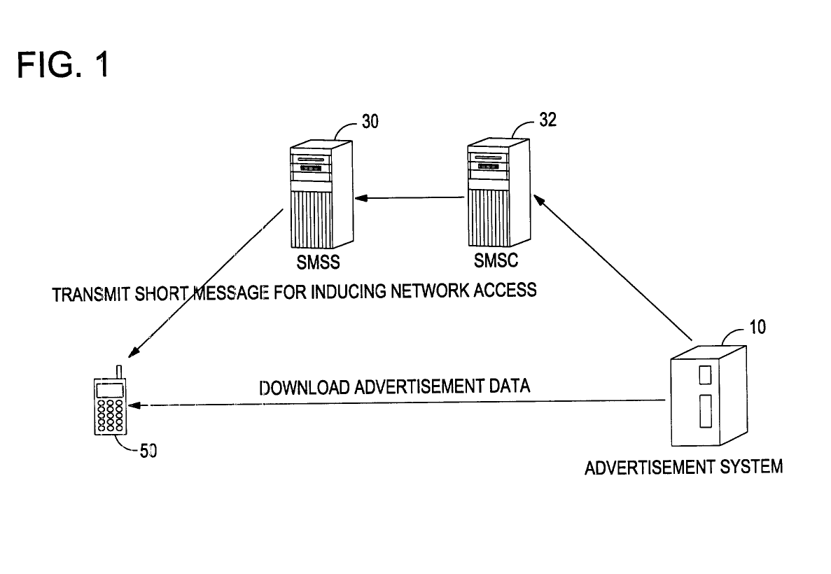

Referring to FIG. 1, an advertisement system 10 of the present invention can transmit a short message to a mobile terminal 50 via a Short Message Service Server (SMSS) 32 and a Short Message Service Center (SMSC) 30 of a wireless communications network. The mobile terminal 50 can access the advertisement system 10 through a Wireless Internet based on a Wireless Application Protocol (WAP).

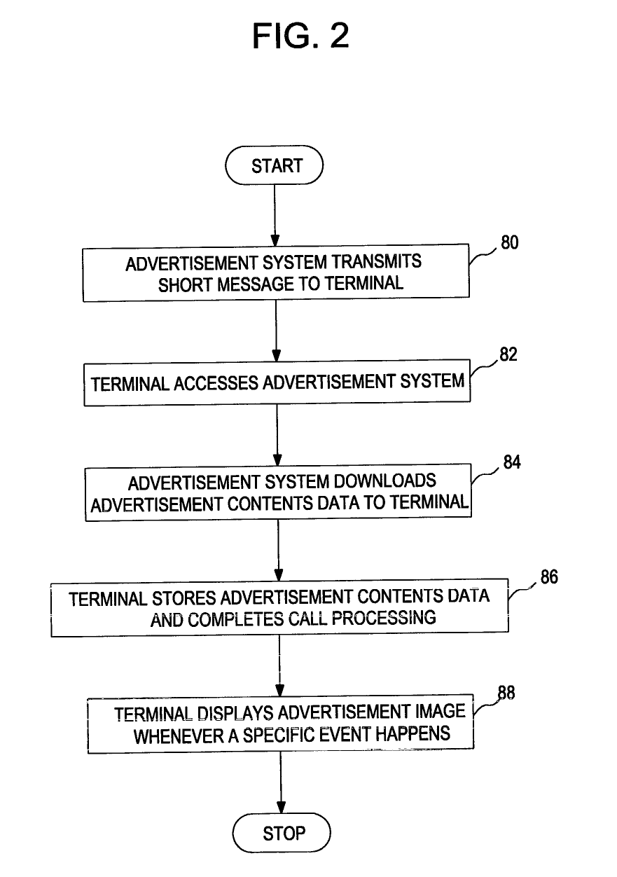

As shown in FIG. 2, the advertisement system 10 first transmits the short message to the mobile terminal 50 via the SMSS 32 and the SMSC 30 when implementing the advertisement (step 80). The short message includes a teleservice ID (TID) and a Callback Uniform Resource Locator (hereinbelow, referred to as “Callback URL”) for accessing the advertisement system 10. Preferably, the TID of the advertisement short message according to the present invention is different from that of common messages, so that the mobile terminal discriminates the short message provided by the advertisement system 10 from the other kinds of messages and thus automatically sets up a connection to the advertisement system 10 in response to the short message. For example, when the TID for the common messages is “65490”, the TID of the advertisement short message of the present invention may be “65497”. Alternatively, however, the advertisement short message of the present invention may be distinguished from other kinds of short messages by another parameter included in the message rather than the TID.

Upon receiving a short message, the mobile terminal 50 determines whether the message is the advertisement short message of the present invention based on the TID. If it is determined that the received short message is the advertisement short message of the present invention, the mobile terminal 50 is automatically connected to the advertisement system 10 through the Wireless Internet based on a certain network protocol supported by the wireless communications network (for example, the Wireless Application Protocol (WAP) proposed by the WAP Forum™), using the Callback URL (step 82). For this purpose, the mobile terminal preferably includes a program module which automatically connects the terminal 50 to the advertisement system 10 when the advertisement short message having the specific TID is received, which is described below in detail.

The connection of the mobile terminal 50 to the advertisement system 10 does not require any user involvement or action (for example, pressing the SEND button). In particular, the mobile terminal 50 maintains silence when receiving the advertisement short message and trying to access the advertisement system 10 while a usual mobile terminal 50 typically notifies the arrival of a short message by beeping, flickering an LED, and turning on a back light of a LCD display. Thus, the user does not know the arrival of the advertisement short message unless the user tries to sending a call. However, the mobile terminal 50 of the present invention informs the user of the arrival of common short messages other than the advertisement message similarly to the usual terminal.

On the other hand, it is preferable that the communications carrier does not bill the charge for calls accessing the advertisement system 10 in response to the advertisement short messages. In such a case, it is necessary to provide a separate Network Access Identifier (hereinbelow, referred to as “NAI”) for the access to the advertisement system 10 different from a common NAI in the mobile terminal 50, so that the mobile terminal 50 accesses the advertisement system 10 using the separate NAI.

When the mobile terminal 50 is connected to the advertisement system 10, the advertisement system 10 downloads one or more advertisement contents data to the mobile terminal 50 (step 84). The advertisement contents data for showing a still image or a moving picture in the display of the mobile terminal 10 is preferably formatted in a Wireless Bitmap (WBMP) or a Simple Image Service (SIS™) format. After the advertisement contents data is downloaded, the mobile terminal 50 stores the advertisement contents data in its memory and completes the call process (step 86). In case that a call is received or transmitted during downloading process, the downloading operation stops immediately and is tried again after a certain time.

In a state that the advertisement contents data is stored in the memory, the mobile terminal 50 displays an advertisement image corresponding to the advertisement contents data whenever a specific event occurs (Step 88). Examples of the events related with the displaying of the advertisement images include an entry to a standby state (opening of a flip or folder of the terminal), a wireless Internet access trial, a completion of the wireless Internet connection, a short message transmission, receiving a call, and turning on or off of the terminal. For example, the mobile terminal begins to display an advertisement image on its display just after the entry of the standby state and maintains the displayed advertisement image until a key is pressed or the standby state. In another example, the advertisement image is displayed from the instance that the user pushes the INTERNET CONNECTION button for accessing the wireless Internet (e.g., the NATE, which is a trademark of SK Telecom Inc), and disappeared when the terminal is connected to the NATE server. Alternatively, the advertisement image may be displayed for a certain time.

The advertisement contents data downloaded in the step 84 accompanies control information for facilitating various controls of the displaying operation. For example, if the user presses a specific button, e.g., the OK button or the SEND button, while the advertisement image is being displayed, the mobile terminal is directly connected to a wireless Internet site related with the advertisement contents so that the user can check the detailed information of the advertisement. On the other hand, multiple kinds of advertisement contents data may be stored simultaneously in the terminal. In such a case, each of the advertisement contents data may be mapped to a respective terminal event. Alternatively, however, plural kinds of contents may be mapped to a certain terminal event, so that each of the plural contents is displayed rotationally whenever the event mapped with the contents occurs in the terminal. Since the advertisement contents data is stored in a non-volatile memory of the terminal 50, the data is maintained even when the power is turned off.

In an embodiment, the advertisement method is carried out only for terminals for which respective users have subscribed for the receipt of the advertisement. Particularly, the subscription may be performed when purchasing the terminal. In such a case, the terminal is equipped with a program module, from the delivery by the factory, for receiving the advertisement data and displaying the advertisement contents. The operator of the advertisement system may compensate for the receipt of the advertisement, for example, by reduction or support of the phone call charges or the terminal costs, or accumulation of incentives. The subscription or the withdrawal of the receipt of the advertisement my be done after the purchasing of the terminal as a matter of course. The procedure for subscribing and withdrawing the advertisement receipt may be similar to those for subscribing and withdrawing any additional service provided by the carrier. If the subscription is withdrawn after the purchasing of the terminal, the compensation is not payed any more for the user. In case that the subscription is carried out after the purchasing of the terminal, the benefit provided to the user in return may be the support of the phone call charges or the accumulation of the incentives.

When a user who has a terminal not equipped with the program for implementing the present invention subscribes for the receipt of the advertisement, it is necessary to upgrade the control program of the terminal. On the other hand, if is necessary to deactivate the function of displaying the advertisement image after the user withdraws the subscription, while it is necessary to activate the function of displaying the advertisement image when the user subscribes again for the receipt of the advertisement. The change of the activation/deactivation state of the function of displaying the advertisement image may be carried out by a short message, and the activation/deactivation state is registered in the non-volatile memory of the terminal. Also, a separate TID may be assigned as well for the change of the activation/deactivation state of the function of displaying the advertisement image.

It is not preferable that a short message entity other than the advertisement system 10 uses a TID identical to that used for carrying the advertisement according to the present invention. Thus, when receiving a request for transmitting a short message having a TID identical to that of the advertisement message according to the present invention, the SMSS 32 checks the IP address of the server issued the request to allow the transmission of the short message only when the request was received from the advertisement system of the present invention.

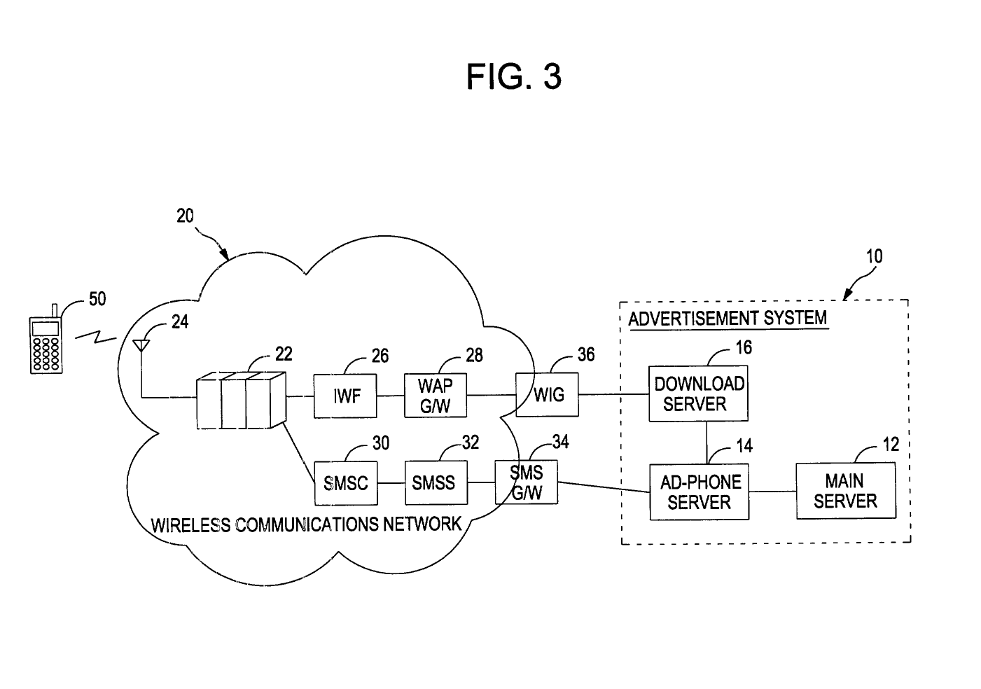

FIG. 3 illustrates an embodiment of the advertisement system 10 shown in FIG. 1 and its network environment. The advertisement system 10 according to the present embodiment, which is suitable for providing the mobile terminal 50 with advertisement contents data based on WMLscript, includes a main server 12, an ad-phone server 14, and a download server 16.

The operator of the advertisement system 10 carries out the push advertisement of the present invention as well as another kinds of advertisements (e.g., the short message advertisement using the SMS). The main server 12 controls the overall system 10 and facilitates the operator to manage the plurality of advertisement businesses. The ad-phone server 14 is engaged in the push advertisement according to the present invention. Namely, the ad-phone server 14 carries out the process of managing user data and choosing advertisement targets for implementing the present invention, transmits short messages to the mobile terminal 50 through the SMSS 32, and enables the download server 16 to download the advertisement contents data to the mobile terminal 50. The download server 16, which stores multiple advertisement contents data, discriminates each mobile terminal on the basis of the terminal number to provide WAP contents designated to the terminal in response to a request of the terminal. In particular, according to the present embodiment, the WAP contents provided by the download server 16 include WMLscripts for facilitating the advertisement contents data specifically assigned to each terminal.

In a wireless communications network 20, a mobile switching center 22 is connected to multiple base stations which relays calls between the mobile terminal 50 and the mobile switching center 22. Here, even though the wireless communication network 20 typically includes one central gateway switch and a plurality of switches connected to the central gateway switch, just a single switching center 22 is shown in FIG. 3 for simplicity. A WAP gateway 28 is connected to the mobile switching center 22 through an Interworking Function (IWF) 26, which is a gateway for interconnecting a wireless communications network to a wired communications network. The WAP gateway 28 converts the HTTP Protocol stack to the WAP Protocol stack, and vice versa.

Meanwhile, the mobile switching center 22 is connected to the SMSC 30 for providing the short message service, which, in turn, is connected to at least one SMSS 32. The SMSC 30, which is connected to the mobile switching center using a SS7 (Signalling System No.7) interface, stores and forwards short messages transmitted or received by the terminals, and provides an interface to an external network.

The ad-phone server 14 of the advertisement system 10 is connected to the SMSS 32 through a SMS gateway server 34. Thus, In case of transmitting a short message to a mobile terminal 50, the ad-phone server 14 requests the forwarding of the short message to the SMSS 32 via the SMS gateway 34. The download server 16, which is connected to the WAP gateway 28 through a Wireless Interface Gateway (hereinbelow, referred to as “WIG”) 36, downloads the advertisement data when the mobile terminal 50 accesses using the callback URL. In an alternative embodiment, however, the ad-phone server 14 may be connected to the SMSS 32 through the WIG 36 as well.

The advertisement system 10 may be operated by a business concern other than the communications carrier operating the wireless communications network 20. In such a case, the download server 16 which is normally operated by the operator of the advertisement system 10 as described above can be operated by the communications carrier or the other business concern as well. All of the advertisement system 10 may be operated by the communications carrier itself as a matter of course. Even though the main server 12, the ad-phone server 14 and the download server 16 are separately shown on the basis of their functions in FIG. 3, some or all of these servers may be implemented in a single physical server.

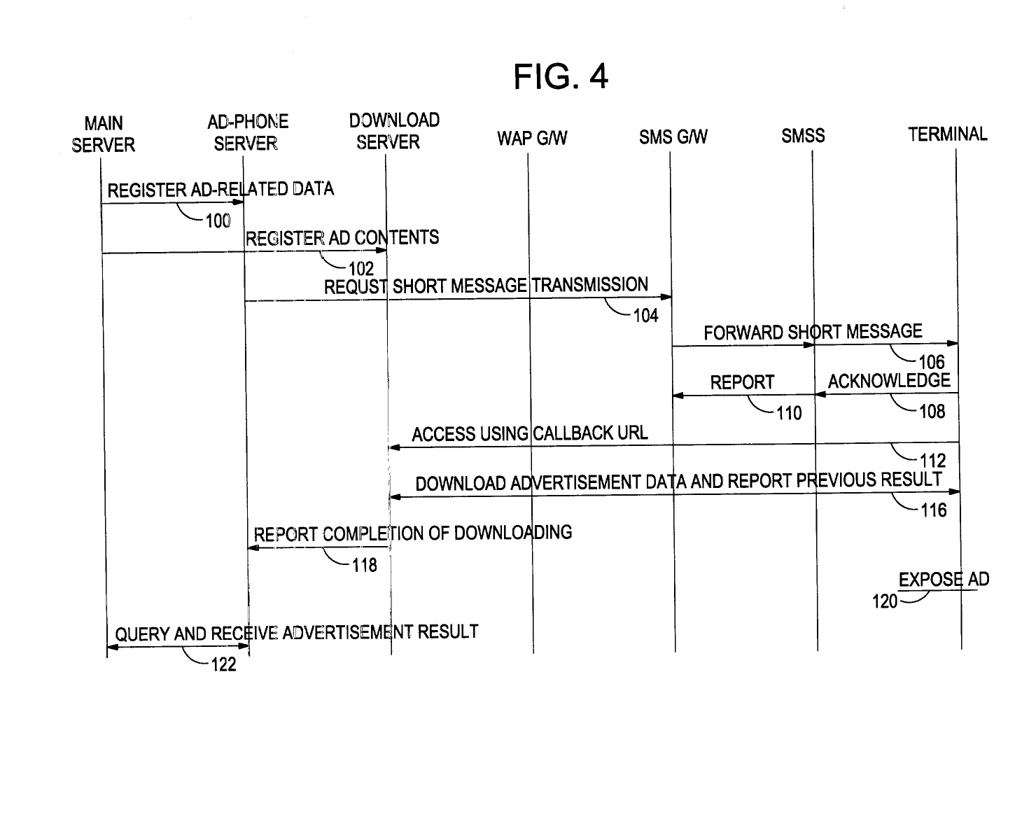

FIG. 4 shows the advertisement method carried out by the advertisement system and the network shown in FIG. 3.

First, the main server 12 registers advertisement-related data such as a sponsor, the advertisement volume, and the target group of each advertisement to the ad-phone server 14 (stp 100). Also, the ad-phone server 14 registers advertisement contents to the download server 16 (step 102). In step 104, the ad-phone server 14 requests the SMS gateway 34 to send short message to the mobile terminals belonging to the target group. Thus, the SMS gateway 34 transmits short messages having the TID assigned to the advertisement to the mobile terminal 50 through the SMSS 32 (step 106). It is preferable that the SMSS 32 analyzes the traffic load of each base station and transmits the short messages when the IWF system is not busy. Upon receiving an acknowledgment signal from the mobile terminal 50, the SMSS 32 reports the transmission result to the SMS gateway 34 (steps 108 and 110).

Subsequently, the mobile terminal 50 receiving the short message is automatically connected to the download server 16 with reference to the callback URL (step 112). When the terminal 50 is connected, the download server 16 provides WAP contents to the mobile terminal 50. Particularly, WMLscript programs embedded in the WAP contents downloads the advertisement contents data previously designated to the terminal 50 (step 116). When the downloading is completed, the download server 16 reports the completion of the downloading to the ad-phone server 14 (step 118). On the other hand, the SMSS 32 may try once or more to retransmit the short messages failed in transmitting in the step 116 later.

Meanwhile, when the downloading of the advertisement contents data is completed, the WMLscript program executed in the terminal 50 stores such data in a memory, so that the advertisement images are displayed on the display whenever respective terminal events occur and the advertisement is exposed to the user (step 120). The details of the advertisement exposure is described below in detail. To receive advertisement result and analysis data, the main server 12 may query the result of the advertisement to the ad-phone server 14 periodically or after each advertisement is performed (step 122).

Just before or after the downloading of the step 116, the terminal 50 reports the previous advertisement analysis data to the ad-phone server 14. The advertisement analysis data may include a mobile terminal ID, an advertisement ID, information of exposed image, an accumulated number of advertisement exposure, an exposure start time, and an exposure end time, and are used for the analyze the detailed response of the user to the advertisement.

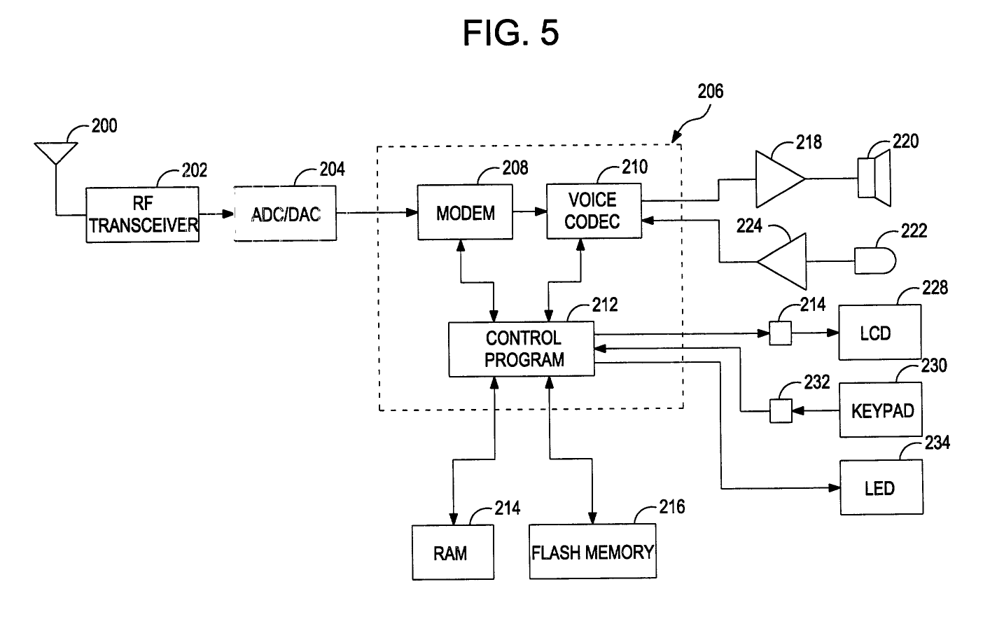

FIG. 5 shows an embodiment of the mobile terminal shown in FIGS. 1 and 3. A Radio Frequency (RF) transceiver 202 receives a wireless signal through an antenna 200 and converts such signal to a downlink baseband signal to provide to an analog-to-digital converter and digital-to-analog converter (ADC/DAC) 204. Also, the RF transceiver 202 converts a uplink base bandwidth signal output by the ADC/DAC 204 to the RF frequency signal to output through the antenna 200. The ADC/DAC 204 converts the analog downlink signal from the RF transceiver 202 to digital data to provide to a digital processor 206. Also, the ADC/DAC 204 converts the digital data from the digital processor 206 to the uplink analog signal to provide to the RF transceiver 202.

The digital processor 206 includes a modem 208, an audio codec 210, and a control program 212. The modem 208 receives a downlink modulated data from the ADC/DAC 204 to demodulate by spectrum despreading, and receives a uplink data from the audio codec 210 to modulate by spectrum spreading. The audio codec 210 decodes the demodulated data to output to a speaker 220 via an amplifier 218, and receives and encodes the audio signal received from a microphone 222 via an amplifier 224 to output the encoded data to the modem 208.

The control program 212 controls the general operation of the internal circuits including the modem 208 and the audio codec 210. The control program 212 can access a RAM 214 for temporarily storing data generated during the operation of the terminal, and a flash memory 216 for storing at least some portion of the control program along with the personal information such as a phone directory and a message box. In particular, according to the present invention, the flash memory 216 stores the advertisement data downloaded from the advertisement system 10, so that the control program 212 display, on a LCD 228, the advertisement image corresponding to the advertisement data.

The LCD 228 is connected to the digital processor 206 through a LCD Driver 226. A keypad 230 is connected to the digital processor 206 through a keypad interface 232. Also, a LED 234 is connected to the digital processor 206 directly or through an additional interface.

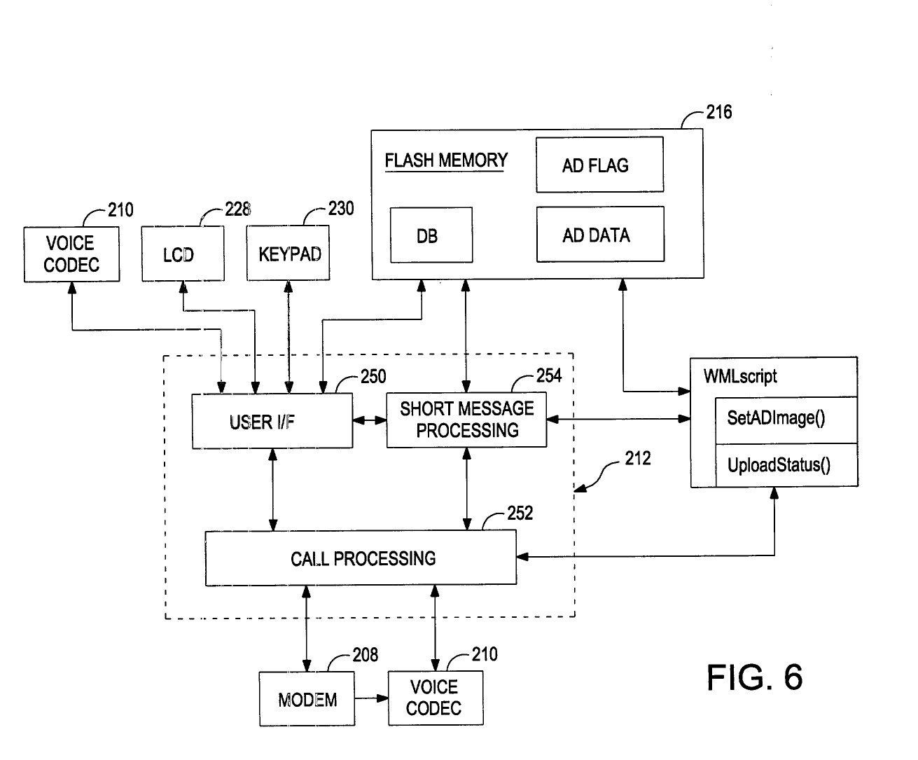

FIG. 6 generally shows the configuration of an embodiment of the control program 212 shown in FIG. 5. The control program 212 includes a user interface module 250, a call processing module 252, and a short message processing module 254. The user interface module 250 displays information of the status of current operations of the terminal and the other information on the LCD 228, and receives user input commands from the keypad 230. The call processing module 252 controls the operation of the modem 208 and the audio codec 210 so as to enable originating a call and answering an incoming call, and facilitates communications operation while a traffic channel is established. The short message processing module 254 sends a short message through the call processing module 252 under the control of the user interface module 250 and processes the short message received through the call processing module 252.

In a preferred embodiment, the short message processing module 254 includes a displaying-and-storing routine for providing the common short message services as well as an automatic access routine for handling the advertisement short message of the present invention. In case that the short message received through the call processing module 252 is a common message, the displaying-and-storing routine makes the user interface module 250 to display the message on the LCD 228 and stores the message in a database in the flash memory 216. On the contrary, however, if the received short message is an advertisement short message according to the present invention, the short message processing module 254 does not notify the user of the receipt of the message nor store the message in the database. Instead, the automatic access routine of the short message processing module 254 makes the call processing module 252 to access the download server 16 using the callback URL.

In the present embodiment, the control program 212 shown in FIGS. 5 and 6 is stored in the flash memory 216 and is loaded and executed in the digital processor 206 when the terminal is turned on. Meanwhile, WML scripts (“SetADImage( )” and “UploadStatus( )” functions) received from the download server 16 of the advertisement system 10 to be executed in the terminal are also shown in FIG. 6. The SetADImage( ) function downloads the advertisement contents data from the download server 16 to store at specific addresses in the flash memory. The UploadStatus( ) function uploads the advertisement analysis data accumulated in the flash memory 216 of the terminal to the download server 16.

Parameters of the SetADImage( ) function and their meanings or functions are summarized in Table 1.

TABLE 1

| Parameter | Type | Description |
|---|---|---|
| url | character | Denotes the absolute path of the advertisement |
| | string | image file. |
| title | character | Denotes the title of image file to be stored in |
| | string | the terminal. |
| kindofimage | integer | Denotes the event at which the image is |
| | | displayed. |
| | | 0: displayed when the terminal is turned on |
| | | 1: displayed when the terminal is turned off |
| | | 2: displayed on a standby state |
| | | 3: displayed when the terminal rings |
| | | 4: displayed during a wireless Internet access |
| | | trial |
| | | 5: displayed when a message is being |
| | | 6: displayed when an internet connection is |
| | | completed |
| imagetype | integer | Denotes the data format of the image file. |
| | | 0: WBMP |
| | | 1: SIS |
| | | −1: an animation lasting five seconds |

The SetADImage( ) function transmits a return value to the download server 16 after the advertisement image data is completely downloaded and stored in the flash memory, so that the download server 16 checks that the data processing is successfully completed for the terminal. As described below, a plurality of advertisement contents files can be transmitted from the download server 16 to the terminal in one downloading session to be stored simultaneously in the terminal. In such a case, the SetADImage( ) function may be repeatedly executed for downloading all the advertisement contents. Alternatively, respective SetADImage( ) function may be defined for each of the plural advertisement contents. Meanwhile, the WAP contents provided by the download server 16 after the automatic access using the callback URL includes an advertisement control information, which is described below.

On the other hand, upon receiving the short message dictating the change of the activation/deactivation state of the function of displaying the advertisement image, the short message processing module 254 sets an advertisement indication flag in the flash memory 216 to indicate an enabling mode or a disabling mode. Only when the advertisement indication flag indicates an enabling mode, the user interface module 250 fetches a corresponding advertisement contents data stored in the flash memory 216 to display on the LCD 228 whenever one of the above-described events occurs.

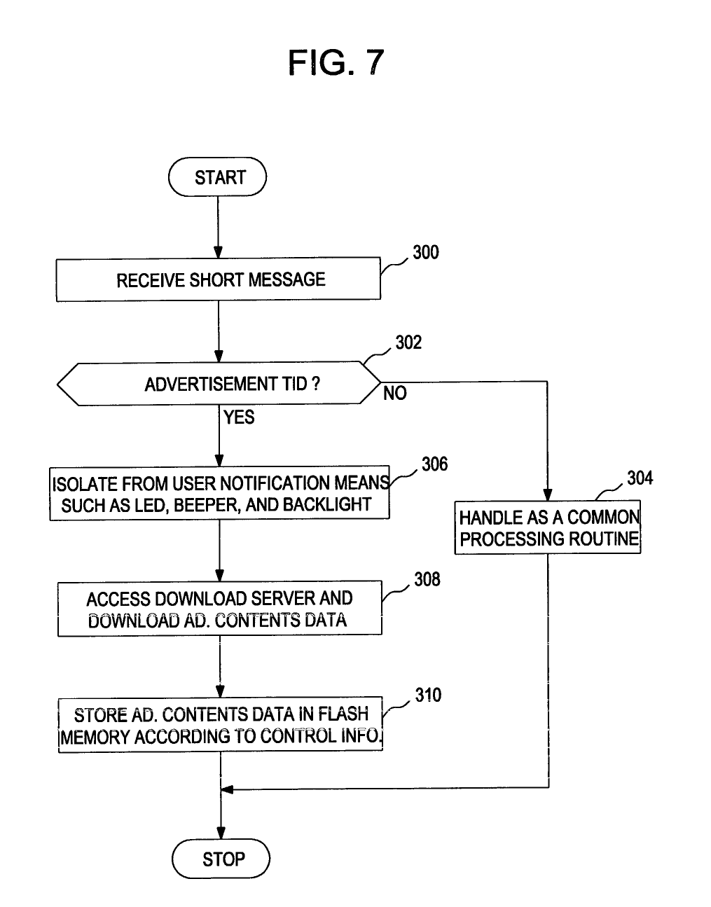

The process of downloading and displaying the advertisement data in the terminal will now be described in more detail in reference with FIGS. 7 through 10.

FIG. 7 shows the steps of receiving and handling a short message in the mobile terminal 50. When a short message is received in step 300, the short message processing module 254 checks the TID to determine whether the short message is the advertisement short message of the present invention or not (step 302). If it is determined that the short message is not the advertisement short message in the step 302, the short message processing module 254 handles the short message according to the common short message processing routine (step 304). Namely, the short message processing module 254 stores the received short message in a message box in the flash memory 216 and informs the user interface module 250 of the arrival of the message. Thus, the user interface module 250 displays an envelope icon on the LCD 228, flickers the LED lamp 234 for a certain time, and beeps through the speaker 220.

On the other hand, if the short message is determined to be an advertisement short message in the step 302, the short message processing module 254 neither store the message in the message box in the flash memory 216 nor inform the user interface module 250 of the arrival of the message (step 306). Instead, the short message processing module 254 provides the call processing module 252 with the callback URL, so that the call processing module 252 tries to access the download server 16 through the WAP. When the terminal 50 is connected to the download server 16, the number of the terminal is provided to the download server 16 by the WIG 36. The download server 16 checks that the user of the terminal is an advertisement subscriber based on terminal number and downloads the advertisement contents data to the terminal (step 308).

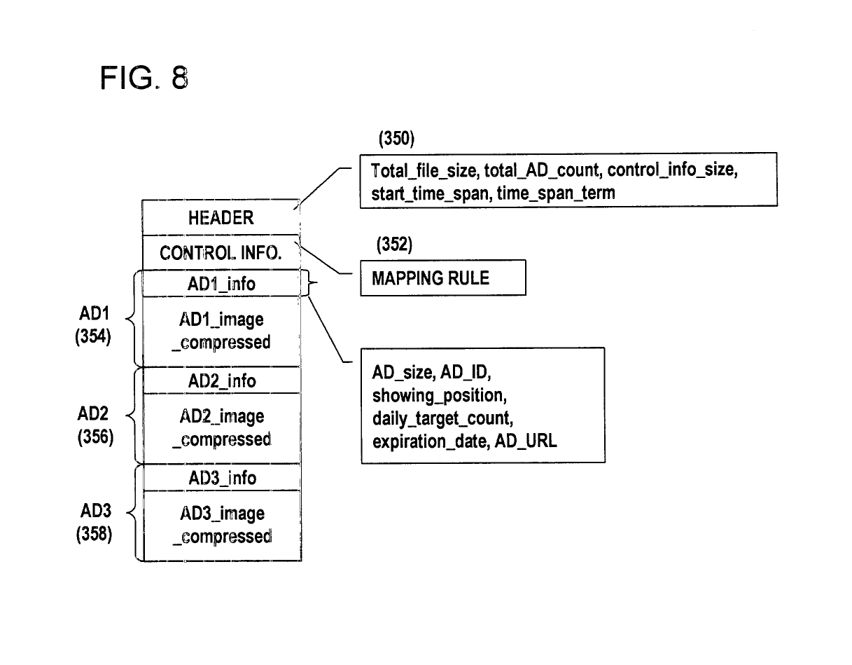

Data provided by the download server 16 to the terminal through one or more consecutive sessions forms a series of data frame. An example of the data frame is shown in FIG. 8. The data frame includes a frame header 350, control information 352, and a plurality of advertisement image data 354 through 358. The frame header 350 includes information of the file size of the total frame (total_files_size), the number of advertisement contents (total_AD_count), the size of control information (control_info_size), the beginning point of time span (start_time_span), and the term of the time span (time_span_term). Here, the time span means a period that an advertisement exposure counter is reset to count again, and the beginning point of time span (start_time_span) means the beginning point of the first time span. Meanwhile, the control information 354 indicates a mapping rule for storing each advertisement image data in the flash memory 216.

Each advertisement image data 354, 356 or 358 includes information of the advertisement image (AD[n]_info) and an advertisement contents file (AD[n]_data_compressed). Each advertisement information (AD[n]_info) includes a size of the advertisement contents file (AD_size), an advertisement ID (AD_ID), information of exposing event (showing_position), a daily target count (daily_target_count), an expiration date of the contents (expiration_date), and a URL associated with the advertisement contents (AD_URL). The advertisement URL indicates a wireless Internet site which can be accessed by pressing a certain key of the terminal while the advertisement is being exposed.

Referring back to FIG. 7, the WML script stores each advertisement information and the advertisement contents file are stored in respective space of the flash memory mapped with them (step 310).

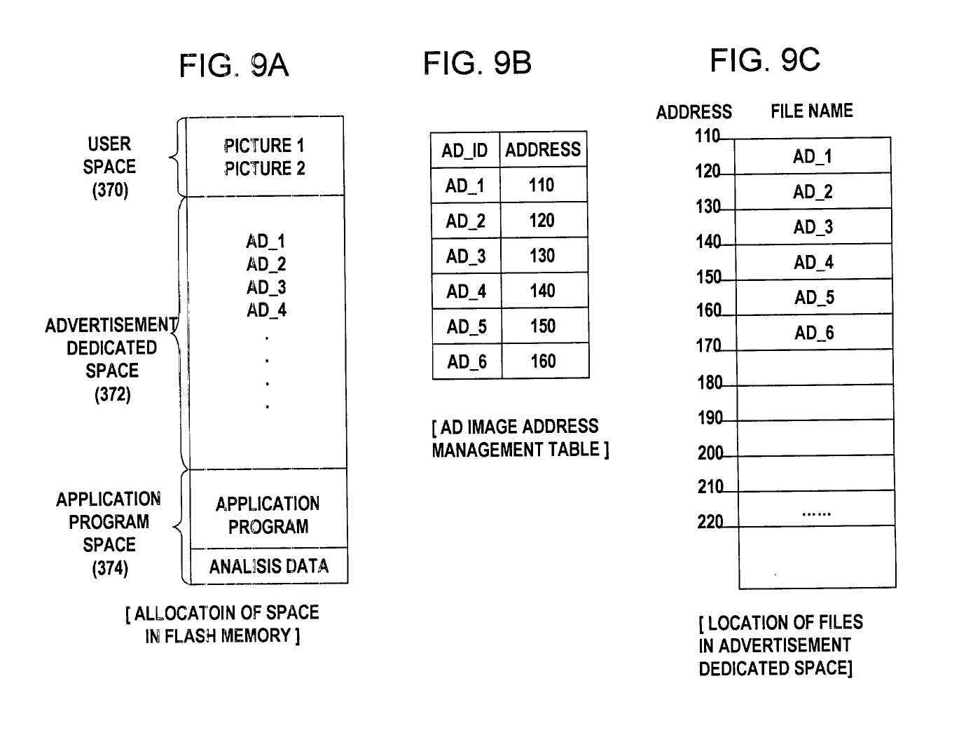

FIG. 9A shows an example of the allocating advertisement data storing space in the flash memory 216 of the mobile terminal. As shown in the drawing, the flash memory 216 includes a user space 370 enabling the user to store a photograph or another kind of image arbitrarily, an advertisement dedicated space 372 for storing the advertisement image, and a space 374 for storing application programs. It is preferable to prohibit a user from arbitrarily accessing the advertisement dedicated space 372. The application program storing space 374 is provided to store the application programs as needed as well as information of advertisement result, i.e., statistics of the exposure of the advertisement images to the user.

In addition to the advertisement image data, an address management table of FIG. 9B is further provided in the database of the flash memory 216. Assuming that the advertisement image data files are physically stored as shown in FIG. 9C in the advertisement dedicated space 372, the address management table stores the addresses of the advertisement image files so that the user interface module 250 easily fetches each advertisement image file.

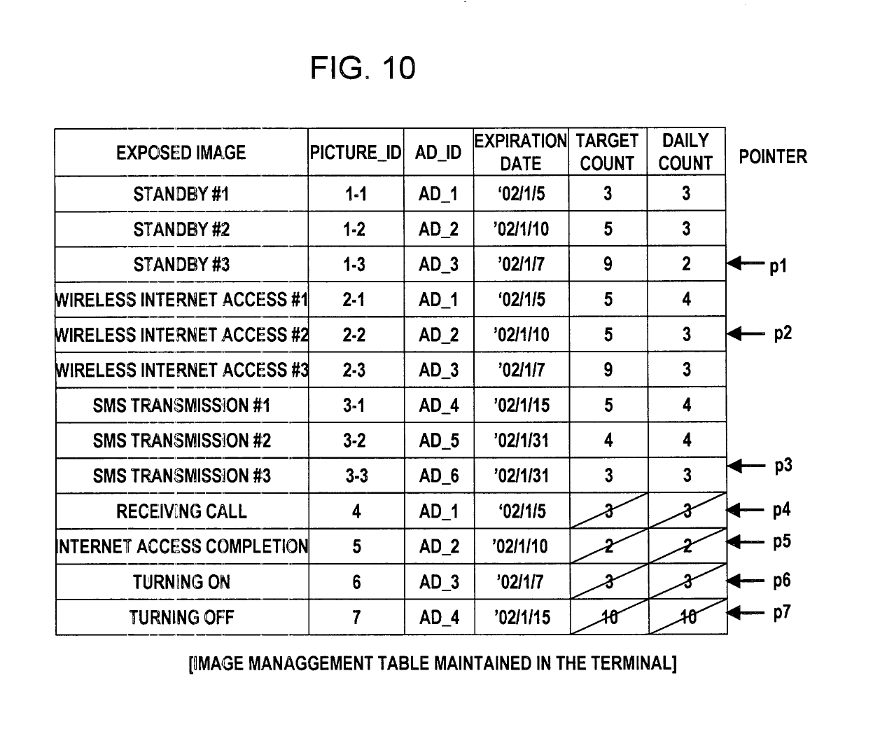

Meanwhile, in the preferred embodiment, an advertisement exposure management table shown in FIG. 10 is additionally provided in the flash memory 216 of the mobile terminal. The advertisement exposure management table stores information about the advertisement image file to be displayed for each event and the exposure status. In the example shown in the table, the advertisement image is displayed when one of seven kinds of events occurs in the terminal. The seven events include “Entry to a standby state”, “Wireless Internet access trial”, “Transmission of a short message”, “Receiving a call”, “Completion of the wireless Internet connection”, “Turning on of the terminal”, and “Turning off of the terminal”.

“Entry to a standby state”, “Wireless Internet access trial”, “Transmission of a short message” of the seven events are mapped into respective three advertisement image files having a picture ID different from each other, so that three advertisement images are displayed alternately. For example, if the previous picture ID of the standby state was “1-1” and an advertisement ID (AD_ID) was “AD_{—}1”, the picture_ID becomes “1-2” and the advertisement image having the advertisement ID (AD_ID) of “AD_{—}2” is displayed for the next event of the “Entry to a standby state.” For this purpose, pointers p1-p7 each of which is provided for respective event indicates the previous picture_ID or the next picture_ID. On the other hand, each of the “Receiving a call,” “Completion of the wireless Internet connection,” “Turning on of the terminal,” and “Turning off of the terminal” events may be mapped into a respective single advertisement image file to be fixedly displayed unless the expiration date is reached.

Accordingly, there exist thirteen picture IDs in the present embodiment because three picture IDs are provided for three of the seven kinds of events. Some or all of the advertisement image files mapped into the thirteen picture IDs may be overlapped. In other words, at least some of the advertisement image files may be displayed for more than one events. For instance, the advertisement image having the advertisement ID of “AD_{—}1” may be displayed for the event of the “Entry to a standby state” as well as the events of “Wireless Internet access” and “Receiving a call”. In the example of FIG. 10, it can be seen that six advertisement images cover thirteen picture IDs.

Each advertisement image file has an expiration date for each picture ID, so that the advertisement image is displayed until the expiration date. Unless a new advertisement image file is provided from the advertisement system 10 by the expiration date, a default advertisement image is displayed for the picture ID. On the other hand, the a target count which denotes a count of desired exposures is set for each picture ID or event, and a daily count which denotes a count of actual exposures is stored in the table. The daily count is counted up for each day, and the advertisement image may not be displayed any more if the daily count reaches the target count.

In order to prevent the misuse of the scheme, however, the repetitive openings and closings of the folders of the terminal (e.g., repetitive action within two seconds) are not admitted for the advertisement exposure in addition to the utilization of the times span mentioned above. That is, it is preferable that the advertisement images are exposed to the user at least a certain the number of times by resetting the daily count in the period of a certain time span. Meanwhile, the number of the advertisement exposures may not be counted for events that occurs frequently or that the user watches the LCD display for only a short time (e.g., “Receiving a call”, “Completion of the wireless Internet connection”, “Turning on of the terminal”, and “Turning off of the terminal” events). Also, the advertisement images can be displayed for events during a certain time period of a day regardless of the daily count in an alternative of the present embodiment.

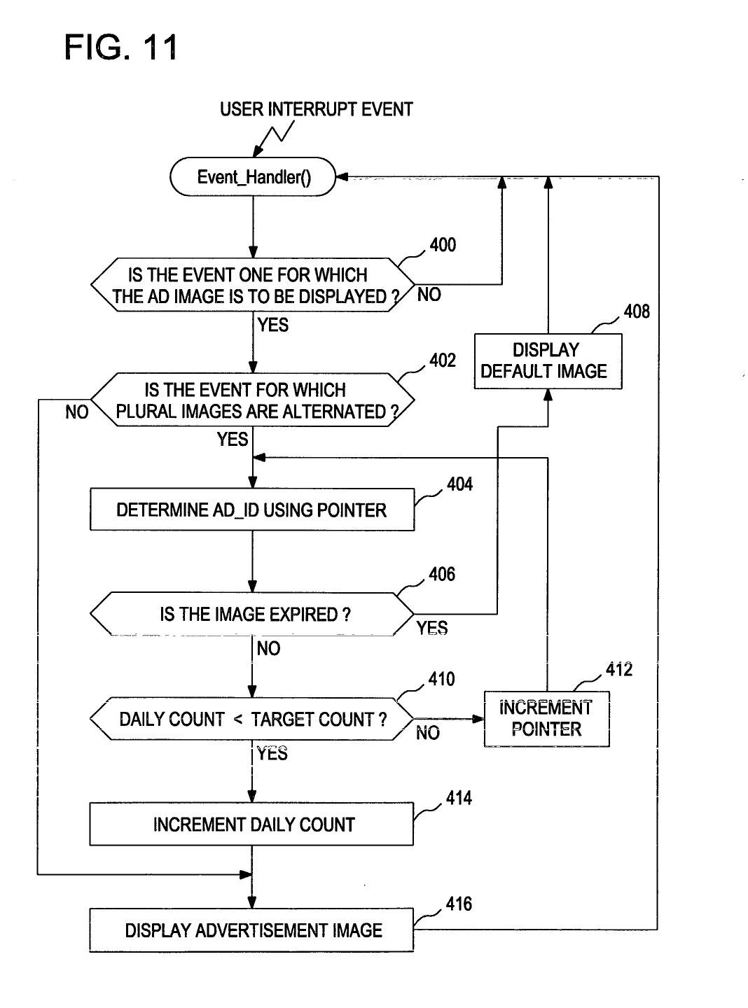

FIG. 11 shows a process of determining the advertisement image to be exposed and displaying the image in the mobile terminal. A event processing function Event_Handler( ) within the user interface module 250 of the terminal control programs continuously checks the change of the terminal status (e.g., a key input, the opening or closing the flip or folder, and the exhaustion of power). Such changes of the status are referred to as an interrupt event in this specification. The function, Event_Handler( ), performs the process of FIG. 11 whenever the interrupt event occurs.

First, the function determines whether the event is one for which the advertisement exposure is performed (step 400). If it is determined that the event is not relevant to the advertisement exposure, the process returns to the standby state to waiting for another interrupt event. If it is determined that the event is one for which the advertisement exposure is performed in the step 400, however, the function determines whether a plurality of advertisement images are exposed alternately for the event (step 402). If the event is not one for which the plurality of advertisement images are alternately displayed but one mapped into a single image, the process proceeds to step 416 to display the advertisement image on the LCD 228.

In case that it is determined in the step 402 that the event is one for which the plurality of advertisement images are displayed alternately, the advertisement ID (AD_ID) of the image to be displayed is determined using the pointer of the event (step 404). Afterwards, it is determined whether expiration date is reached for the advertisement image (step 406). If the image is expired, the process returns to the standby state to waiting for another interrupt event after displaying a default image in step 408. If, however, the image is not expired, it is determined whether the daily count is less than the target count (step 410). If the daily count is equal to the target count, the pointer is incremented in step 412 and the steps 404 through 410 are carried out repeatedly. If the daily count is equal to the target count for all the images assigned to the event, the process returns to the standby state. Meanwhile, if the daily count is less than the target count, the daily count are incremented and the advertisement image is displayed (steps 414 and 416).

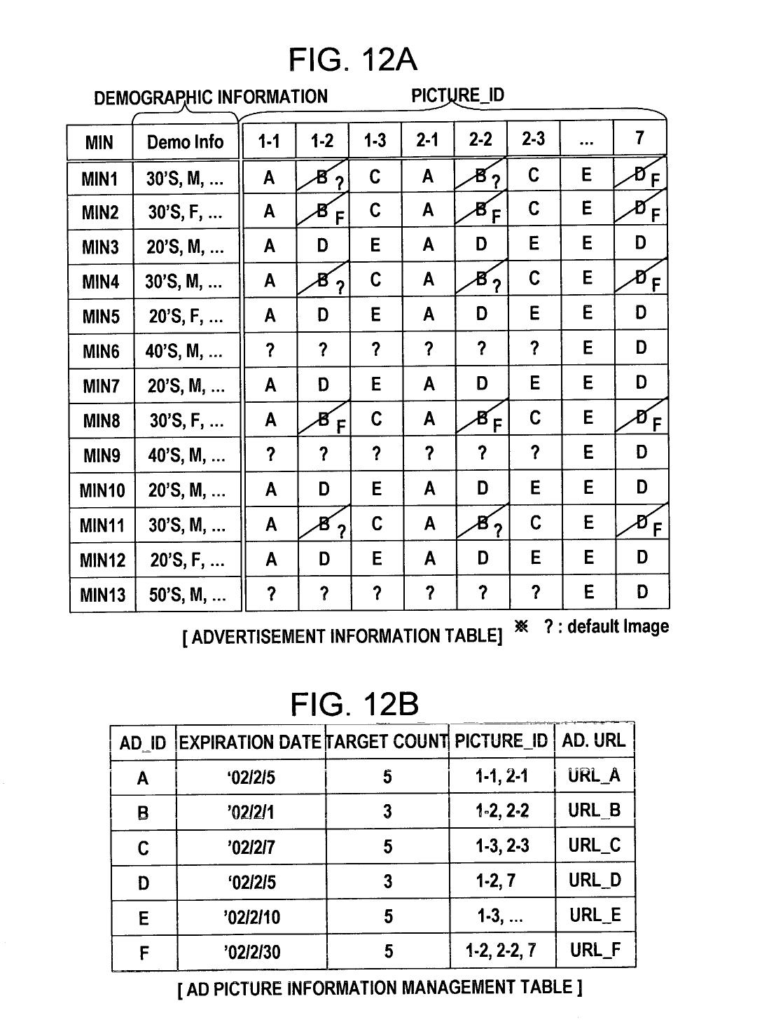

The advertisement system 10 maintains information about advertisement data stored in the terminal of the user subscribed to the service of the present invention. FIG. 12A shows an example of the final advertisement information table maintained by the advertisement system 10. The advertisement information table stores demographic information and types of advertisement image data for each advertisement event for all the terminals. In FIG. 12A, the advertisement ID is represented by a single character, contrary to FIG. 10, for the sake of simplicity. A question mark (?) denotes the default image of the terminal.

The advertisement system 10 carries out targeted transmission considering the demographic information and attitude or response of the recipient to the advertisement with reference to the advertisement information table of FIG. 12B. An example of an advertisement scenario to create the final advertisement information table of FIG. 12A is described below. We assume that the advertisement image data is transmitted three times to the terminals. We further assume that the advertisement image data of Table 2 is transmitted to male and female users in 30s before Jan. 31, 2002 in the first time. Those data is transmitted to and stored in the terminals MIN1, MIN2, MIN4, MIN8, and MIN11.

TABLE 2

| | | | | | | | | |
|---|---|---|---|---|---|---|---|---|
| AD. Exposure | 1-1 | 1-2 | 1-3 | 2-1 | 2-2 | 2-3 | . . . | 7 |
| Screen | | | | | | | | |
| AD_ID | A | B | C | A | B | C | . . . | D |

We further assume that the advertisement image data of Table 3 is transmitted to male and female users in 20s before Jan. 31, 2002 in the second time. Those data are transmitted to and stored in the terminals MIN3, MIN5, MIN7, MIN10, and MIN12.

TABLE 3

| | | | | | | | | |
|---|---|---|---|---|---|---|---|---|
| AD. Exposure | 1-1 | 1-2 | 1-3 | 2-1 | 2-2 | 2-3 | . . . | 7 |
| Screen | | | | | | | | |
| AD_ID | A | D | E | A | D | E | . . . | D |

If we further assume that the advertisement image data is transmitted to female users in 20s or 30s who have a terminal in which the expired B file is set for the screens, 2-1 and 2-2 on Feb. 2, 2002 in the third time, the compressed advertisement contents file is transmitted to and stored in the terminals MIN2, MIN5, MIN8, and MIN12. At the time, it is unnecessary to transmit advertisement data which is not expired but it is enough to transmit advertisement data which is expired. Thus, only the advertisement image data shown in Table 4 is transmitted in this case.

TABLE 4

| | | | |
|---|---|---|---|
| AD. Exposure Screen | 1-1 | 2-2 | 7 |
| AD_ID | F | F | F |

In the terminal having received the compressed advertisement contents file, the image data for the corresponding advertisement event is updated from the expired B picture data to F picture data. Meanwhile, the terminals, MIN1, MIN4, and MIN11, having not downloaded such data displays the default image for the picture ID, 1-2, 2-2, and F, for which the expired image B, had been exposed.

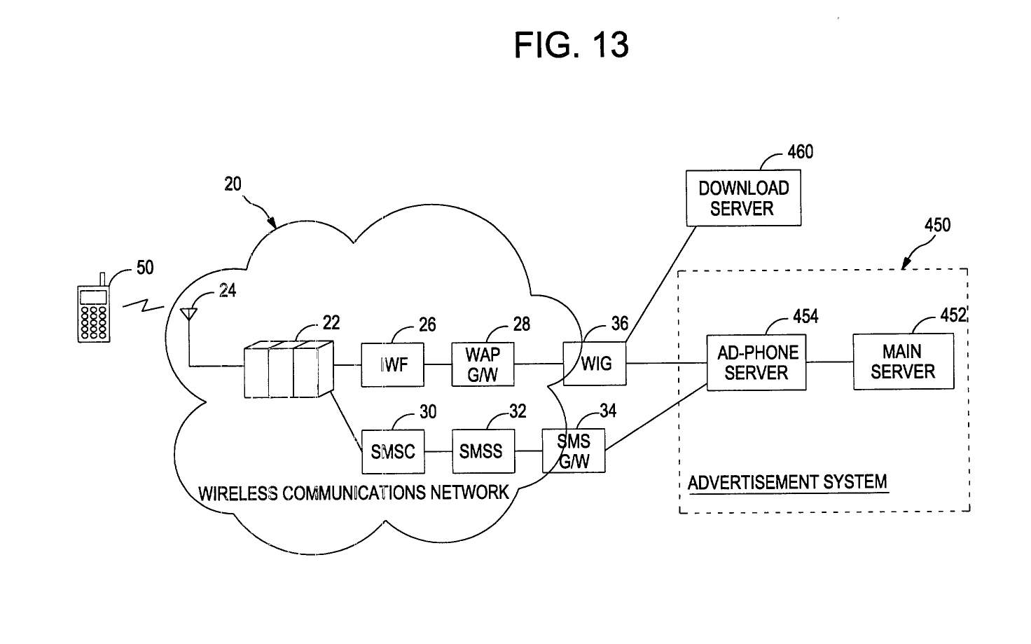

In the embodiment described with reference to FIGS. 3 through 9, the WMLscript provided by the download server 16 of the advertisement system 10 stores the advertisement contents data in the terminal. Alternatively, however, a virtual machine (V/M) stored in the terminal can perform this function instead of the WMLscript. FIG. 13 shows the advertisement system and network environment according to such an embodiment.

In the embodiment shown in FIG. 13, the advertisement system 450 includes a main server 452 and an ad-phone server 454. The functions of the main server 452 and the ad-phone server 454 are similar to the functions of the counterpart shown in FIG. 3. However, a contents download server 460 providing the advertisement image contents is disposed outside the advertisement system 450 in FIG. 13. The download server 460 may be operated by the wireless communications carrier or a separate virtual machine solution provider. However, the download server 460 might be operated by the operator of the advertisement system 450 as well.

When the terminal 50 having received the advertisement short message is automatically connected to the advertisement system 450, the advertisement system 450 redirects the connection to the download server 460, so that the download server 460 provides the terminal 50 with advertisement contents. In the present embodiment, it is preferable that the advertisement contents provided to the terminal 50 is formatted to a certain frame after more than one advertisement image file is compressed. The compressed advertisement contents frame include control information, so that the virtual machine operating as an advertisement dispatcher can control the advertisement exposure based on the control information. After downloading the compressed advertisement contents file, the terminal 50 decapsulate the frame and uncompresses the compressed image file to restore the advertisement image data. Subsequently, the terminal 50 stores the advertisement image data in its internal memory and completes the call processing. If a call is received or transmitted while the compressed advertisement contents file is being downloaded, the download is stopped and resumed later. Similarly to the previous embodiment, the terminal displays the advertisement image corresponding the advertisement data whenever a specific event occurs. If the user presses a certain key of the terminal while the advertisement image is being exposed, the wireless Internet site related with the advertisement image is directly connected and detailed information about the advertisement can be seen.

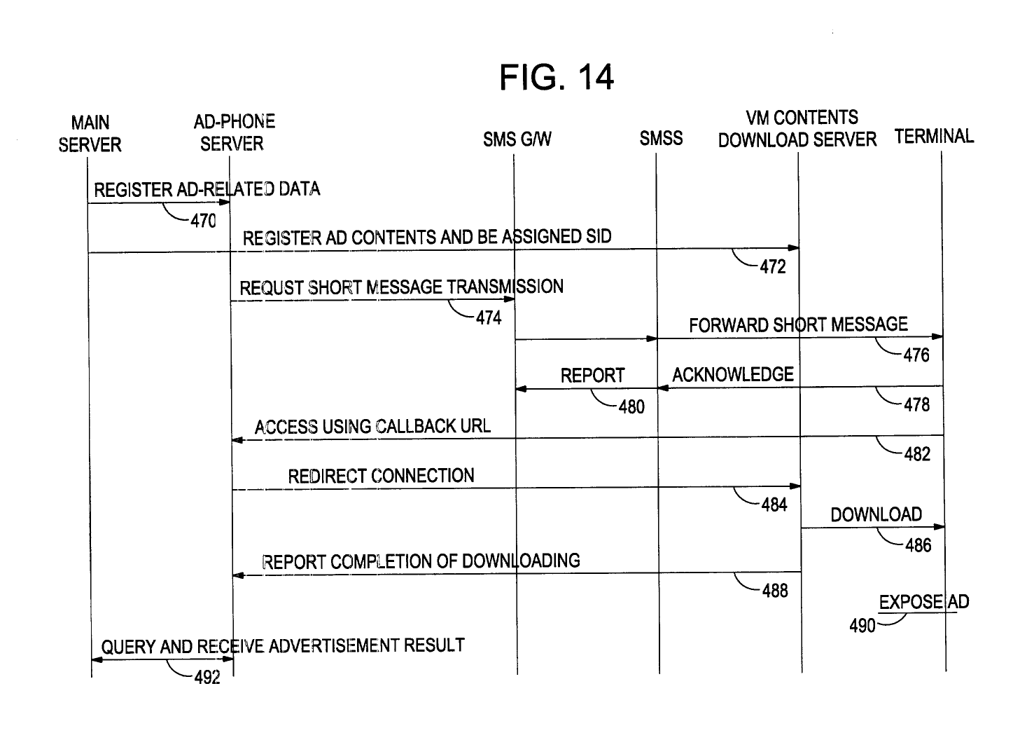

FIG. 14 shows in detail the advertisement method carried out in the advertisement system and in the network environment shown in FIG. 13.

First, the main server 452 registers the advertisement-related data such as the sponsor, advertisement contents, and the target groups to the ad-phone server 454 (step 470). The ad-phone server 454 registers the advertisement contents to the download server 460, and is assigned a service ID for the contents (step 472). The ad-phone server 454 requests the SMS gateway 34 to send a short message to the mobile terminals belonging to the target groups, and thus the SMS gateway 34 transmits short messages to the mobile terminal 50 (step 476). Upon receiving an acknowledgment signal from the mobile terminal 50, the SMSS 32 reports the transmission result to the SMS gateway 34 (steps 478 and 480).

Subsequently, the automatic access V/M of the terminal 50 having received the short message is automatically connected to the download server 460 via the WAP gateway 28. That is, if automatic access V/M of the terminal 50 is automatically connected to the ad-phone server 454 with reference to the callback URL, the ad-phone server 454 redirects the connection to the download server 460 (steps 482 and 484). The ad-phone server 454 provides a VMscript program to the terminal so that the terminal downloads the virtual machine advertisement contents from the download server.

Meanwhile, the callback URL may be set to the URL of the WAP gateway 28 instead of that of the ad-phone server 454. In such an embodiment, the WAP gateway 28 redirects the connection to the download server 460, also. When the terminal 50 is connected, the VM contents download server 460 downloads the compressed advertisement contents file including the advertisement contents which is prepared in advance (step 486). Upon completion of the downloading, the download server 460 reports the completion of the downloading to the ad-phone server 454 (step 488).

When the compressed advertisement contents is completely downloaded, the advertisement storing V/M of the terminal 50 uncompresses the compressed file so that the advertisement image corresponding to the image data is displayed whenever the specific event occurs as described above. Thus, the advertisement is exposed to the user (step 490). The details of the advertisement exposure is described below in detail.

Meanwhile, the main server 452 may query the advertisement result to the ad-phone server 454 periodically or after each advertisement is performed to receive the advertisement result along with some statistics (step 492).

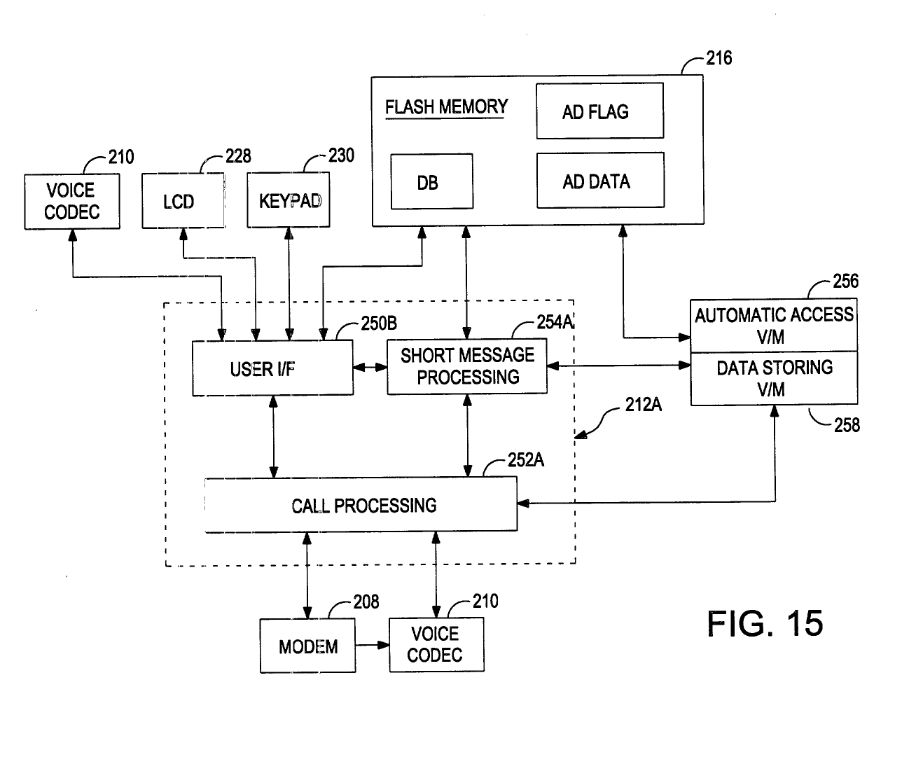

FIG. 15 shows the configuration of the program executed by the mobile terminal suitable for the advertisement method of FIG. 14. The control program 212 A includes a user interface module 250A, a call processing module 252A, a short message processing module 254A, an automatic access Virtual machine 256, and a data storing Virtual machine 258. The user interface module 250 displays information of the status of current operations of the terminal and the other information on the LCD 228, and receives user input commands from the keypad 230. The call processing module 252A controls the operation of the modem 208 and the audio codec 210 so as to enable originating a call and answering an incoming call, and facilitates communications operation while a traffic channel is established. The short message processing module 254A sends a short message through the call processing module 252A under the control of the user interface module 250A and processes the short message received through the call processing module 252A.

In the present embodiment, the short message processing module 254A enables the user interface module 250a to display the message on the LCD 228 and stores the message in a database in the flash memory 216 in case that the received short message is a common message. On the contrary, however, if the received short message is an advertisement short message according to the present invention, the short message processing module 254A does not notify the user of the receipt of the message nor store the message in the database. Instead, the short message processing module 254A makes the automatic access V/M 256 to access the ad-phone server 454 using the callback URL. On the other hand, upon receiving the short message dictating the change of the activation/deactivation state of the function of displaying the advertisement image, the short message processing module 254A sets an advertisement indication flag in the flash memory 216 to indicate an enabling mode or a disabling mode.

The automatic access V/M 256 automatically accesses the VM contents download server 460 through the ad-phone server 454 according to the direction of the short message processing module 254A. When being connected to the download server 460, the data storing V/M 258 downloads the compressed advertisement contents file personalized to the terminal and uncompresses the file to store in the flash memory 216. In the present embodiment, the automatic access V/M 256 and the data storing V/M 258 are stored in the space 374 for storing application programs storing space 374 shown in FIG. 9A and loaded executed by being loaded to the RAM just after the turning-on of the terminal or later. While these virtual machines may be loaded in the terminal from the shipment of the terminal, the virtual machines can be loaded by an upgrading operation after the shipment. Also, the two virtual machines may be incorporated into a single machine in its form.

When the advertisement indication flag indicates the enabling mode, the user interface module 250 fetches the advertisment contents data stored in the flash memory 216 to display the advertisement image corresponding to the data whenever the above-mentioned event occurs.

Since another features of the system and the method shown in FIGS. 13 and 14, respectively, are similar to those of FIGS. 3 and 4, detailed descriptions thereof are omitted.

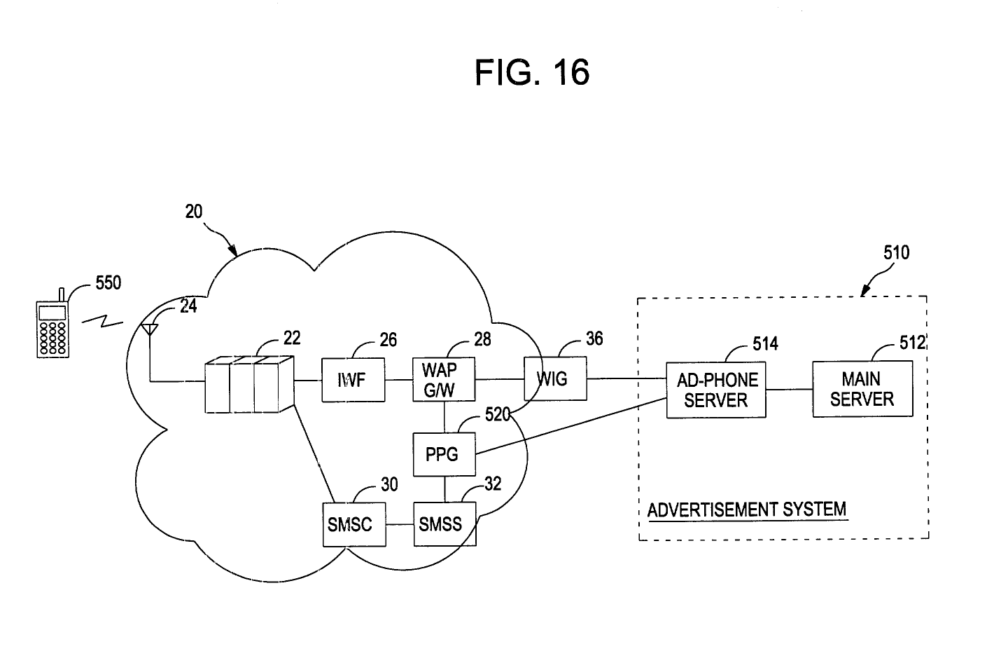

Even though the advertisement system provides the terminal with the URL by the SMS push to provide the advertisement image data in the embodiments described above, the advertisement image data can be forwarded to the terminal by a WAP push technology, alternatively. FIG. 16 shows the connective relationship between the advertisement system and the mobile terminal in such an embodiment. FIG. 16 is similar to FIGS. 3 and 13 except that a Push Proxy Gateway (PPG) is added and the configuration of the advertisement system is simplified.

In the advertisement system 510, a main server 512 controls the overall system 510 and facilitates the operator to manage the plurality of advertisement businesses. The ad-phone server 14 is engaged in the push advertisement according to the present invention. Namely, the ad-phone server 14 carries out the process of managing user data and choosing advertisement targets for implementing the present invention. Also, the ad-phone server 514 provides the PPG 520 with the advertisement data and the information about the terminals belonging to the target to request to transmission of the advertisement data to the targeted terminals.

The PPG 520 receives push contents through the ad-phone server 514 by a Push Access Protocol (PAP), converts the push contents to a format suitable for the wireless communication network, and transmits to the terminal by a push Over-The-Air (OTA) protocol. For the purpose, the PPG 520 is connected to the ad-phone server 514 and is connected to the IWF 26 through the WAP gateway 28. Meanwhile, the WAP gateway 28 provides the PPG 520 with information about the terminal to which a WAP session is established, so that the PPG 529 can refer to the session information when pushing the contents to the terminal. The details of the WAP push and the PPG are disclosed in WAP Push Architectural Overview (WAP-250-PushArchOverview-20010703-a), Push message (WAP-251-PushMessage-20010322-a), Push Proxy Gateway Service (WAP-249-PPGService-20010713-a) published by the WAP Forum (trademark of Wireless Application Protocol Forum Ltd.).

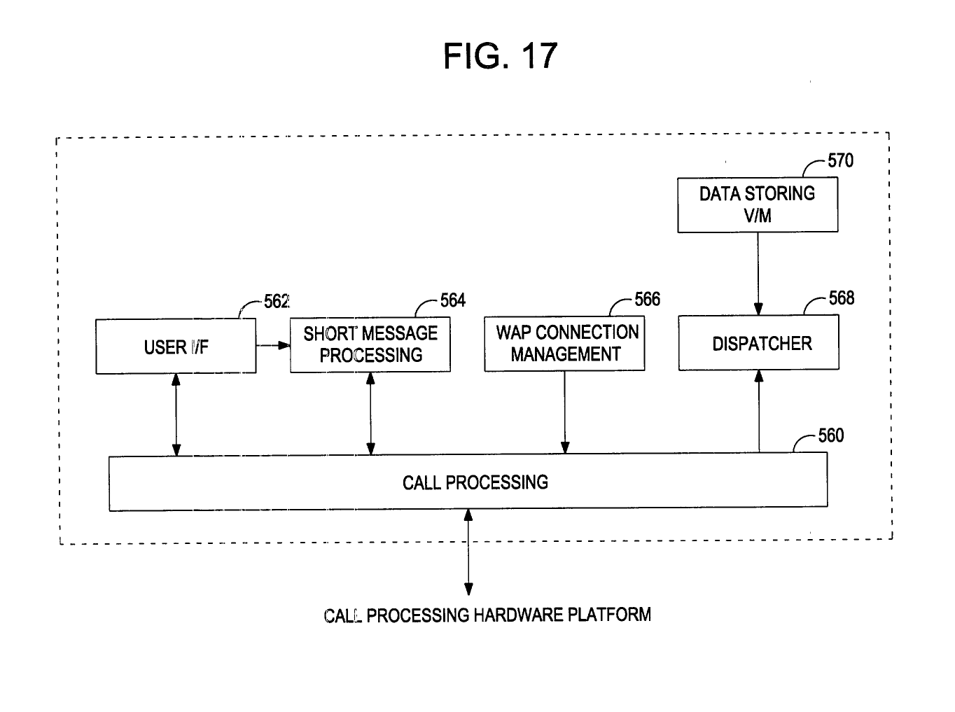

FIG. 17 shows the configuration of the program executed by the mobile terminal of FIG. 16. A call processing module 560 controls the operation of the modem and the audio codec so as to enable originating a call and answering an incoming call, and facilitates communications operation while a traffic channel is established. A user interface module 562 displays information of the status of current operations of the terminal and the other information on the LCD, and receives user input commands from the keypad. A short message processing module 564 sends a short message through the call processing module 560 under the control of the user interface module 562 and processes the short message received through the call processing module 560.

In the present embodiment, the short message processing module 564 enables the user interface module 562 to display the message on the LCD and stores the message in a database in the flash memory in case that the received short message is a common message. On the contrary, however, if the received short message is a Session Initiation Request (SIR) which is described below in detail, the short message processing module 564 does not notify the user of the receipt of the message nor store the message in the database. Instead, the short message processing module 564 makes the WAP connection management module 516 to access the wireless Internet to establish a push session to the PPG 520.

When the contents are pushed from the PPG 520, an application program dispatcher 568 determines an application program to be used for the contents data based on the header of the push message, and provides the contents data with the application program. In particular, according to the present embodiment, the application program dispatcher 568 provides the contents data to a data storing V/M 570. The data storing V/M 570, which performs a function similar to the WML script program, SetADImage( ), receives the compressed advertisement contents file from the application program dispatcher 568 and uncompresses the file to store the advertisement image data in the memory. The user interface module 562 fetches the stored image data and displays the advertisement image whenever the above-mentioned event occurs.

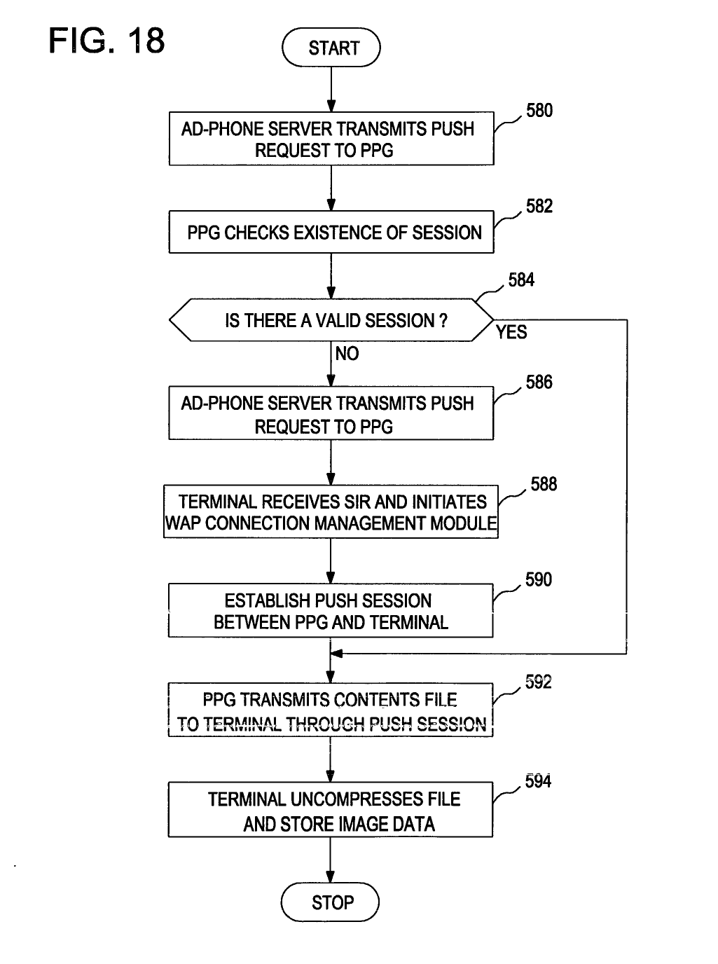

FIG. 18 shows the advertisement method implemented in the wireless communications network of FIG. 16.

First, the ad-phone server 514 transmits a push request including a targeted terminal number and the compressed advertisement contents file to the PPG 520 (step 580). Upon receiving the push request message, the PPG 520 checks whether a valid WAP session is established for the terminal (step 582). As mentioned above, the PPG 520 receives, periodically or in real time, session information of the terminal indicating whether a WAP session is established to the WAP gateway 28. Alternatively, however, the PPG 520 can query the WAP session information for a specific terminal to the WAP gateway 28 when necessary.

If it is determined that a valid WAP session is established for the terminal in step 584, the process proceeds to step 592. If, however, it is determined in the step 584 that there is no valid WAP session for the terminal, the push session establishment process of the steps 586 through 590 is performed.

In step 586, the PPG 520 transmits the Session Initiation Request (SIR) to the terminal through a short message. Preferably, the TID of the SIR short message transmitted by the PPG 520 is different from that of a common short message so that the terminal 550 discriminates the SIR short message transmitted by PPG 520 from the common short message. For example, in the case that the TID used for the common short message is “65490”, the TID of the SIR short message may be set to “65495”. Alternatively, however, the short message of the present invention can be discriminated from the common short message by another parameter included in the short message header rather than the TID.

If it is determined that the received short message is the SIR short message, the short message processing module 564 of the terminal 550 activates the WAP connection management module 566 (step 588). The WAP connection management module 566 is a Session Initiation Application (SIA) for initiating the push session to the PPG. The execution of the WAP connection control module 566 results in the establishment of the push session between the PPG 520 and the terminal 550 in step 590.

After it is determined in the step 584 that there exists a valid WAP session for the terminal or the push session is established in the step 590, the PPG 520 transmits the compressed advertisement contents file to the terminal through the push session in the step 592. Whenever the file is pushed, the application program dispatcher 568 reads the header of the push message, determines that the received data is advertisement contents, and provides the compressed advertisement contents file to the data storing V/M 570. The data storing V/M 570 uncompresses the file to store the advertisement image data in the memory (step 594). When the receipt of the compressed advertisement contents file is completed, the push session between the terminal 550 and the PPG 520 is terminated and the call channel is released. The terminal displays the advertisement image corresponding to the advertisement data whenever the specific event occurs.

Meanwhile, the media types defined by the WAP Forum to be delivered by the WAP push includes a Wireless Markup Language (WML), a Mobile Multimedia File Format (MMF), a Cache Operation, a Service Indication (SI), and a Service Loading (SL). While contents can be delivered by a single push process in case of the WML, MMF, and CO services, the URL of a contents provider is pushed to the terminal and the terminal access to the contents provider using the URL in case of the SI and SL services. Any delivering scheme can be employed for the implementation of the advertisement contents push of the present invention. However, in case of pushing through the MMF service or CO service, PPG may terminate the push operation and retry again later if it is determined in the step 584 that there is a valid session for the terminal. The CO service is suitable for updating the expiration date of a data file stored in the terminal. Meanwhile, in case that the advertisement contents is pushed using the SI and SL service, it is preferable that the application program dispatcher 568 or the WAP connection management module 566 automatically accesses the advertisement system 510 without any permission of the user.

Although the present invention has been described in detail above, it should be understood that the foregoing description is illustrative and not restrictive. Those of ordinary skill in the art will appreciate that many obvious modifications can be made to the invention without departing from its spirit or essential characteristics. For example, in the case that the advertisement image contents is provided to the terminal based on the SMS push, the terminal preferably performs the tasks of: automatic connection to the server, receipt of the contents, storing, and reporting, as described above. Here, even though several embodiments for implementing the tasks were presented above, various combinations of the internally-stored program or virtual machines and the script programs such as the WMLscript can be employed as well. Also, even though a separate program module or function can exist for each task, some of the program modules or functions can be incorporated into a bigger one or segmented additionally.

On the other hand, it was described that the contents provided by the server to the terminal is compressed before the transmission. Those skilled in the art can modify the detailed compressing scheme in various aspects including the ratio and portion of the compressed data in the whole frame.

Although the callback URL is transmitted in the short message, a default URL stored in the terminal can be used for the terminal to be connected to the sever.

Thus, it should be apparent that the invention can be modified in arrangement and detail without departing from such principles. We claim all modifications and variation coming within the spirit and scope of the following claims.

What is claimed is:

1. In a wireless communications terminal having a displaying unit, and a nonvolatile memory for storing data, a method of displaying an advertisement image comprising the steps of:
(a) receiving advertisement image data from a predetermined server;
(b) storing the advertisement image data in the nonvolatile memory; and
(c) when a predetermined event occurs in the terminal, reading out the advertisement image data from the nonvolatile memory and displaying an advertisement image corresponding to the advertisement image data on the displaying unit.

2. The method as claimed in claim 1, wherein the event is one selected from the group consisting of: entry to a standby state, wireless Internet access trial, transmission of a short message, receiving a call, completion of the wireless Internet connection, turning on of the terminal, turning off of the terminal, and a combination of at least two of them.

3. The method as claimed in claim 1, wherein said step (a) comprises the steps of:
(a1) receiving a short message comprising a service identification code;
(a2) determining whether the service identification code corresponds to a transmission service of the advertisement image data;
(a3) when the service identification code corresponds to a transmission service, accessing the server; and
(a4) receiving the advertisement image data from the server.

4. The method as claimed in claim 3, wherein the short message further comprises a resource locator,
wherein the server is accessed using the resource locator in said step (c).

5. The method as claimed in claim 4, wherein the wireless communications terminal stores a first and a second wireless Internet access numbers in a predetermined storage,
wherein the wireless Internet is accessed using the first wireless Internet access number when the server is accessed using the resource locator, while the wireless Internet is accessed using the second wireless Internet access number when the server is accessed without the resource locator.

6. The method as claimed in claim 5, wherein a plurality of advertisement image data files and control information for the data files are received sequentially at one session,
wherein each of the control information includes a wireless Internet address related to a corresponding to an advertisement image data file.

7. The method as claimed in claim 6, wherein the wireless communications terminal is connected to the wireless Internet address, when a user presses a predetermined key while the advertisement image is being displayed on the displaying unit, to receive and display advertisement information related to the advertisement image.

8. The method as claimed in claim 4, wherein the advertisement image data is received from the server by WAP push technology.

9. The method as claimed in claim 3, wherein the a predetermined activation flag is written in a predetermined location of the nonvolatile memory in the case that the service identification code indicates a subscription status of the advertisement image displaying service,
wherein said step (c) is carried out only when the user subscribed to the advertisment image displaying service.

10. A wireless communications terminal comprising:
a displaying unit;
a call processing circuit for transmitting and receiving signals;
a nonvolatile memory for storing data;
means for storing advertisement image data received from a predetermined server through said call processing circuit in said nonvolatile memory; and
means for displaying an advertisement image corresponding to the advertisement image data on said displaying unit when a predetermined event occurs.

11. The wireless communications terminal as claimed in claim 10, wherein the event is one selected from the group consisting of: entry to a standby state, wireless Internet access trial, transmission of a short message, receiving a call, completion of the wireless Internet connection, turning on of the terminal, turning off of the terminal, and a combination of at least two of them.

12. A method for transmitting advertisement image data to a wireless communications terminal having a displaying unit, and a nonvolatile memory for storing data through a network so that an advertisement image corresponding to the advertisement image data is displayed on the terminal, said method comprising the steps of:
(a) transmitting a short message including a predetermined service identification code indicating an advertisement image displaying service so that the terminal requests the advertisement image data through the network; and
(b) providing the advertisement image data and a predetermined script program in response to the request, so that the script program stores the advertisement image data in a predetermined location of the nonvolatile memory.

13. A method for transmitting advertisement image data to a wireless communications terminal having a displaying unit, and a nonvolatile memory for storing data through a network so that an advertisement image corresponding to the advertisement image data is displayed on the terminal, said method comprising the steps of:
(a) transmitting the advertisement image data to an external server so that the external server stores the advertisement image data;
(b) transmitting a short message including a predetermined service identification code indicating the advertisement image data transmission service to the terminal so that the terminal can request to the advertisement image data through the network; and
(c) transmitting the request to the external server in response to the request so that the external server provides the advertisement image data to the terminal.

14. The method as claimed in claim 13, wherein the short message further comprises a resource locator,
wherein the terminal requests the advertisement image data through the network using the resource locator.
